(19) United States
(12) Patent Application Publication
(10) Pub. No.: US 2013/0298028 A1
(43) Pub. Date: Nov. 7, 2013

(54) MULTIFUNCTIONAL INPUT DEVICE

(71) Applicants: Shahar Porat, Ein Carmel (IL); Yuval Bachrach, Haifa (IL)

(72) Inventors: Shahar Porat, Ein Carmel (IL); Yuval Bachrach, Haifa (IL)

(21) Appl. No.: 13/976,035

(22) PCT Filed: Feb. 9, 2012
(86) PCT No.: PCT/US12/24537

§ 371 Date: Jun. 26, 2013

Related U.S. Application Data
(60) Provisional application No. 61/477,000, filed on Apr. 19, 2011.

(51) Int. Cl. G06F 3/0487

(52) U.S. Cl. CPC G06F 3/0487
USPC 715/727; 715/748

(57) ABSTRACT

A system and method for interacting with a graphical user interface (GUI) on a display means of a computing device. The system includes a multifunctional input device configured to interact with a simplified graphical user interface (GUI) of the computing device. The multifunctional input device is configured to provide improved accessibility to the computing device for users having limited computing knowledge and/or skills, as well as limited physical and/or cognitive abilities.

### CROSS-REFERENCE TO RELATED APPLICATIONS

The present application claims the benefit of U.S. Provisional Patent Application Ser. No. 61/477,007, filed Apr. 19, 2011, the entire disclosure of which is incorporated herein by reference.

### FIELD

The present disclosure relates to input devices for computers, and, more particularly, to a multifunctional input device for improving accessibility and ease-of-use of a computing device.

### BACKGROUND

With the advent of personal computers (PCs) and other personal computing devices (i.e. netbook, tablet, smartphone), as well as the introduction of the internet, users of such computing devices are able to perform a variety of tasks. For example, a user may browse the web, access and exchange email, access social servicing websites, etc. However, with the increase in use of computers and computer services, the complexities of computer programs have also increased. Although recent technological advancements in computing devices may allow a greater range of services able to be provided, persons having little or no basic knowledge of computers or lacking basic computer skills may have difficulty when accessing a computer due to complex computer programs and/or the user interface of the computer.

As technology advances, so to does the average life expectancy in many countries. As such, many countries have an increasing elderly population, wherein some elderly persons may be increasingly drawn towards using a computer because of the services that a computer may provide. For example, families may connect online more than ever before. Many families may own digital cameras and use email to communicate and share photos or videos online. Additionally, families may connect via web-enabled video services.

Although some elderly persons may be open to use of a computer and the internet, the complex computer programs and user interface of a computer may cause some elderly to refrain from owning and/or even using a computer. In particular, some elderly may have limited computer skills or little or no knowledge of how to even operate a computer and may find the learning curve associated with operating a computer very intimidating. Additionally, some elderly may have physical limitations (e.g. sight limitations, hearing limitations, lack of eye-hand coordination and hand and fingers dexterity) that may prevent them from accessing a computer by way of conventional methods of navigating a computer (i.e. mouse, keyboard, etc.).

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a block diagram of a system for providing improved accessibility to and ease-of-use of a computer consistent with various embodiments of the present disclosure;

FIG. 2 illustrates a block diagram illustrating the system of FIG. 1 in greater detail;

FIG. 3 illustrates a top view of one exemplary embodiment of a multifunctional input device consistent with the present disclosure;

FIG. 4 illustrates one exemplary embodiment of a graphical user interface (GUI) shown on a display of a computing device consistent with the present disclosure;

FIG. 5 illustrates another exemplary embodiment of a GUI shown on a display of a computing device consistent with the present disclosure; and

FIG. 6 is a flow diagram illustrating one embodiment for interacting with a graphical user interface (GUI) on a display means of a computing device consistent with various embodiments of the present disclosure.

### DETAILED DESCRIPTION

By way of overview, the present disclosure is generally directed to a system and method for providing improved accessibility to a computing device for users having limited computing knowledge and/or skills. In particular, a system consistent with the present disclosure includes a multifunctional input device configured to communicate with a computing device (such as, but not limited to, a desktop, a laptop, and/or a mobile computing device) and a graphical user interface (GUI) of the computing device.

The multifunctional input device includes one or more sensors configured to capture and transmit data to the computing device based on user input. In particular, the multifunctional input device includes one or more user-selectable buttons and/or toggles configured to allow a user to navigate and/or manipulate the GUI on a display of the computing device. The multifunctional input device also includes an integrated camera configured to capture images and/or videos. The captured images and/or videos may be used, for example, for social networking, wherein a user may share the images and/or videos. Additionally, a user may use the camera for the magnification of printed information (e.g. magazine, newspaper, etc.), wherein the camera may scan printed information and transmit the information to the computing device to forward to the display. The multifunctional input device may include additional components, including, but not limited to, audio components configured to receive and aurally reproduce audio content from the computing device and a microphone configured to capture audio data, such as a user's voice for use in applications executed on the computing device.

A system consistent with the present disclosure may provide users with limited computer skills, knowledge, and/or abilities (e.g. novice users, elderly, etc.) a more accessible and user-friendly means of operating a computing device. Additionally, a multifunctional input device consistent with the present disclosure may allow a user to perform multiple tasks on a computer from a single device, thereby reducing the number of peripherals a user must learn how to use. In addition, the multifunctional input device described herein also reduces the number of computer peripherals and corresponding computer input/output ports needed, thereby making the arrangement of PC slots, I/O ports and/or communication links (i.e. wires) easier for a user to manage.

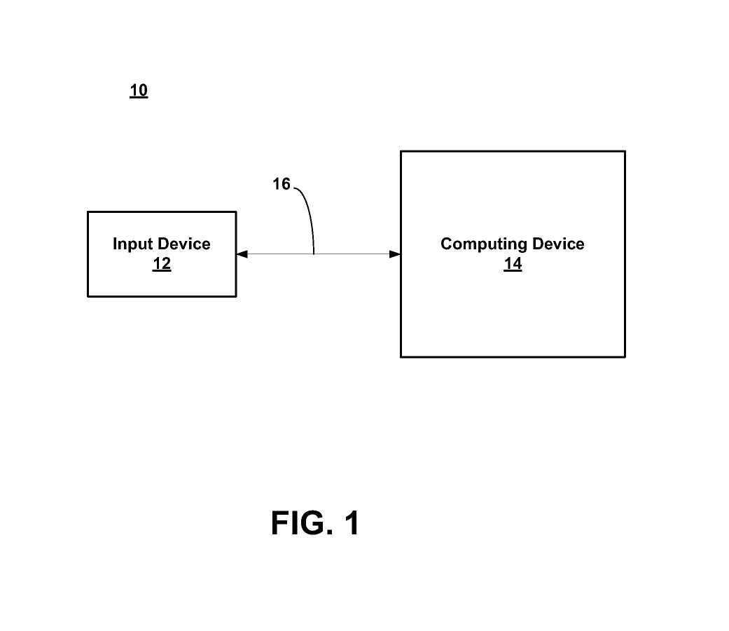

Turning to FIG. 1, one embodiment of a system 10 consistent with the present disclosure is generally illustrated. The system may include an input device 12 and a computing device 14. As shown, the input device 12 may be configured to access and communicate with the computing device 14 over a communication link 16. In one embodiment, as described in greater detail herein, the input device 12 may be configured to wirelessly communicate with the computing device 14, wherein the communication link 16 may include streaming of wireless signals between the input and computing devices 12, 14. It should be noted that in other embodiments, the input device 12 may be configured to communicate with the computing device 14 via a cable (communication link 16 is a wired-connection) having a standard peripheral interface, such as, for example, RS-232C, PS/2, USB, etc.

The computing device 14 may include, for example, a personal computer (PC), netbook, tablet, smartphone, and other personal computing devices. The input device 12 may generally be understood to include a human interface device (HID) (or peripheral) configured to communicate with the computing device 14. In particular, the input device 12 may include multiple forms of input. For example, the input device 12 may be configured to allow a user to input spatial data to the computing device to control operations of the computing device 14 (i.e. navigate a GUI running on the computing device 14). Additionally, the input device may be configured to allow a user to capture data related to images and or sound and transmit such captured data to the computing device 14.

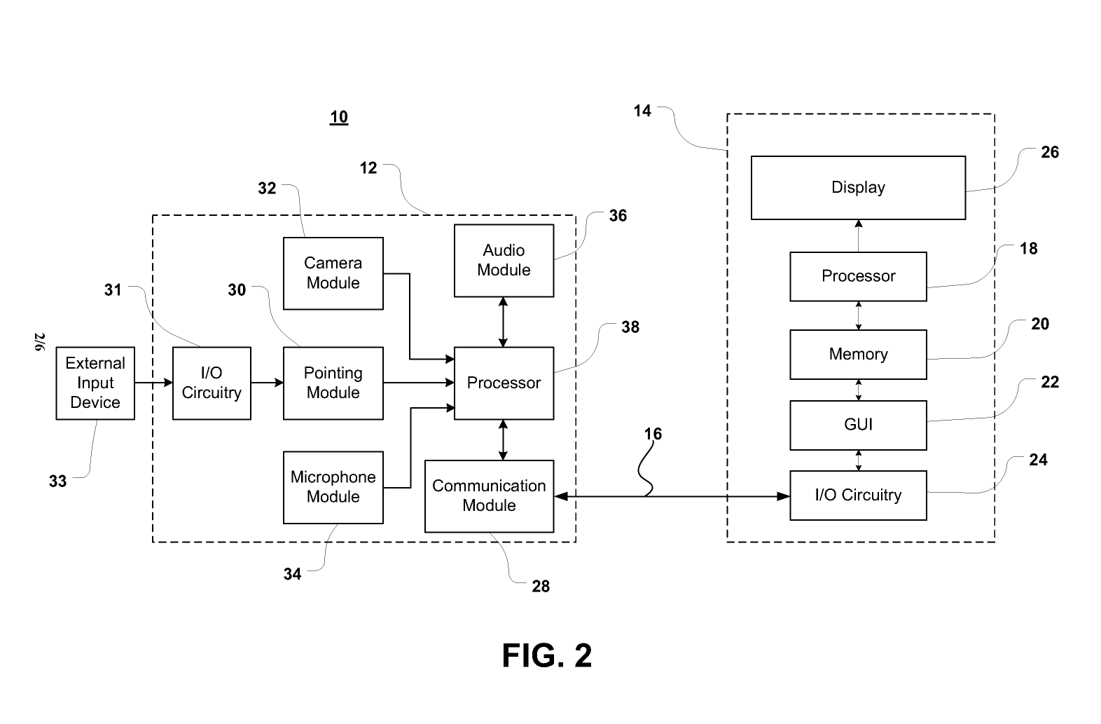

Turning now to FIG. 2, the system 10 of FIG. 1 is illustrated in greater detail. In the illustrated embodiment, the computing device 14 may include a processor 18, memory 20, a graphical user interface (GUI) 22, input/output (I/O) circuitry 24, and/or other suitable components. The computing device 14 may further include a display 26, wherein a user may view the GUI 22 by way of the display 26.

As shown, the input device 12 may include a communication module 28 configured to allow the input device 12 to communicate with the computing device 14 via a communication link 16. In the illustrated embodiment, the communication module 28 may include, for example, a wireless module configured to allow the input device 12 to wirelessly communicate with the computing device 14 via a wireless transmission protocol. In particular, the communication module 28 may be WiFi enabled, permitting wireless communication according to one of the most recently published versions of the IEEE 802.11 standards as of January 2012. For example, the communication module 28 may permit wireless communication between the input device 12 and the computing device 14 according to, for example, the most recently published versions of IEEE 802.11 ac, IEEE 802.11 ad, and/or other 60 GHz standards as of January 2012. As such, the I/O circuitry 24 of the computing device 14 may be configured to communicate with the communication module 28 of the input device 12 according to the above described standards. In particular, the I/O circuitry 24 may include a communication module (not shown) similar to the communication module 28 of the input device 12, thereby allowing the computing device 14 to wirelessly transmit and receive signals to and from the input device 12. Other wireless network protocols standards could also be used, either in alternative to the identified protocols or in addition to the identified protocol. Other network standards may include Bluetooth, an infrared transmission protocol, or wireless transmission protocols with other specifications.

It should be noted, in other embodiments, the communication module 28 may include, for example, a wired-connection module, wherein the input device 12 and computing device 14 are configured to communicate with one another via a cable having a standard peripheral interface, such as, for example, RS-232C, PS/2, USB, etc.

In the illustrated embodiment, the input device 12 may further include a pointing module 30, a camera module 32, a microphone module 34, an audio module 36, and/or a processor 38.

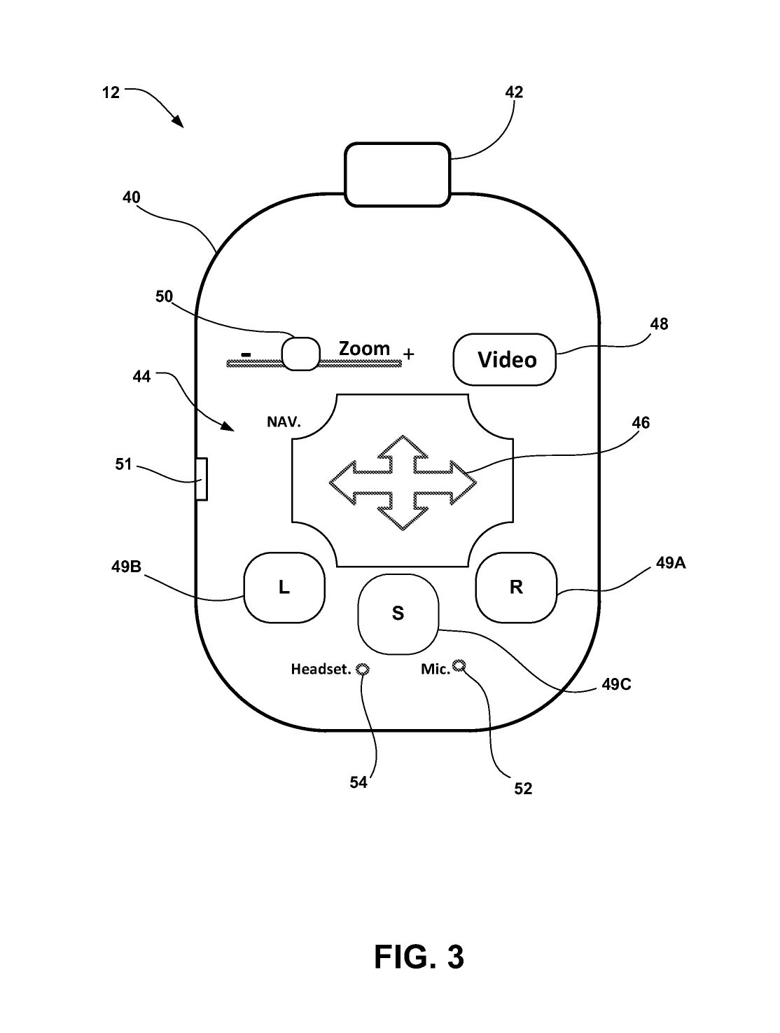

The pointing module 30 may be configured to detect operation of one or more user selectable function inputs 44 (buttons and/or toggles shown FIG. 3) to generate user selection input data. The communication module 28 may be configured to transmit the selection input data to the computing device 14, thereby allowing a user to navigate and/or manipulate the GUI 22 on the display 26 based on the selection input data.

As shown, the input device 12 may further include I/O circuitry 31 configured to allow an external input device 33 to communicate with the input device 12. In particular, the external input device 33 may be configured to allow a user to navigate the GUI 22 on the display 26. More specifically, the external input device 33 may include one or more user selectable function inputs, such as, for example, switches, buttons, toggles, etc. The pointing module 30 may be configured to detect operation of the external input device 33 to generate user selection input data, wherein the communication module may transmit the selection input data based on operation of the external input device 33 to the computing device 14, thereby allowing navigation of the GUI 22.

The external input device 33 may be configured to allow a user having limited mobility to navigate the GUI 22. In particular, the external input device 33 may include one or more single function inputs, such as, for example, switches. In one embodiment, the external input device 33 may include three switches. The first and second switches, when operated, may allow a user to cycle through the GUI 22. For example, the first switch, when operated, may allow a user to cycle in a first direction through options presented in the GUI 22 and the second switch, when operated, may allow to configured to allow a user to cycle in a second direction opposite the first direction. The third switch, when operated, may allow a user to select an option (such as, for example, an application) highlighted in the GUI 22. In other embodiments, the external input device 33 may include other user selectable function inputs generally understood by one skilled in the art.

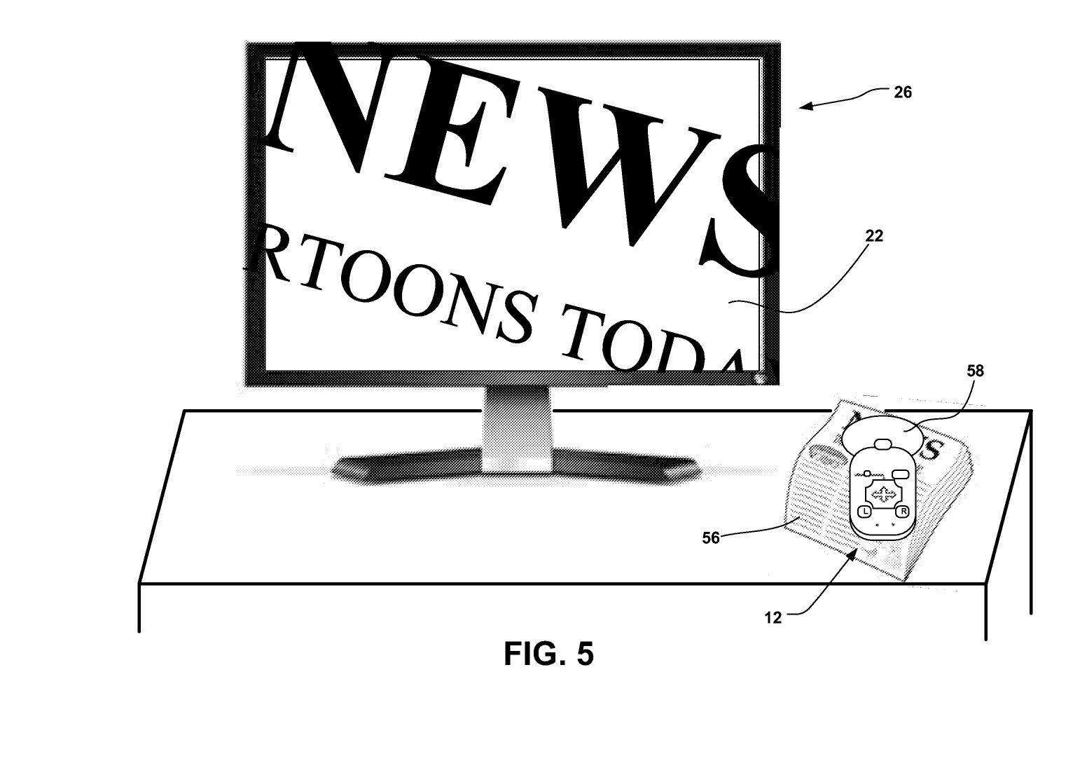

In addition to allowing a user to navigate the GUI 22, the input device 12 may include a camera module 32 configured to receive and/or store images and/or video captured with a camera (shown in FIG. 3) and transmit captured images and/or video to the computing device 14. The captured images and/or videos may be used, for example, for social networking, wherein a user may wish share the images and/or videos with friends and family. Additionally, as shown in FIG. 5, a user may use the camera for the magnification of printed information (e.g. magazine, newspaper, etc.), wherein the camera may scan printed information and transmit the information to the computing device 14 to exhibit on the display 26, as will be described in greater detail herein.

The input device 12 may further include a microphone module 34 configured to receive and/or store audio data, such as the user's voice, captured with a microphone (shown FIG. 3) and transmit captured audio data to the computing device 14. Similar to images and/or videos, audio data, such as the user's voice, may be used for social networking, wherein a user may communicate with friends and family. Additionally, the input device 12 may also include an audio module 36 configured to receive audio content from the computing device 14 and aurally reproduce such audio content on an audio output means, such as headphone jack (shown FIG. 3), speakers (not shown), etc.

The input device 12 may also include a processor 38. The processor 38 may be configured to control the communication module 28 to communicate with the computing device 14. More specifically, the processor 38 may be configured to control the communication module 28 to send data from the pointing module 30, camera module 32, and/or microphone module 34 to the computing device 14. Additionally, the processor 38 may be configured to control the communication module 28 to receive data from the computing device 14 and send such data to at least the audio module 36. The processor 38 may also be configured to control individual components of the input device 12 (e.g. processor 38 may control the camera 42, such as auto-focusing the camera 42).

Turning to FIG. 3, a top view of one exemplary embodiment of a multifunctional input device 12 consistent with the present disclosure is illustrated. Generally, the input device 12 may include a housing 44, wherein the communication module 28, pointer module 30, I/O circuitry 31, camera module 32, microphone module 34, audio module 36, and/or processor 38 may be disposed within the housing 44. As shown, the input device 12 may include user selectable function inputs 44. The function inputs 44 may include a navigation input 46 for allowing a user to move (i.e. left, right, up, down) a cursor, or the like, on a GUI 22 on the display 26 of the computing device 14. The function inputs 44 may further include a video mode input 48 configured to allow a user to activate the camera 42 to take still images and/or videos.

Additionally, the function inputs 44 may include simplified navigation inputs, shown as buttons 49A and 49B and a selecting input 49C. The navigation inputs 49A and 49B may allow a user to cycle through programs and applications presented in the GUI 22 and input 49C may allow a user to select one of the programs or applications. For example, in one embodiment, operation of input 49A may allow a user to cycle through options in the GUI 22 to the right and operation of input 49B may allow a user to cycle through the options to the left. The function inputs 44 may also include a magnifying input 50 allowing a user to manipulate the view (i.e. increase/decrease the size) of content on the display 26. In other embodiments, the input device 12 may include additional or alternative user selectable function inputs 44, such as, for example, one or more trackballs, and/or a touchscreen. The input device may also include one or more connection ports 51 configured to coupled the external input device 33 to the multifunctional input device 12. As generally understood, the connection port 51 may include any known wired connection interface, such as, for example, RS-232C, PS/2, USB, etc. The input device 12 may also include a microphone 52 configured to receive audio content, such as voice data. The input device 12 may also include a headphone jack 54 allowing a user to listen to audio content.

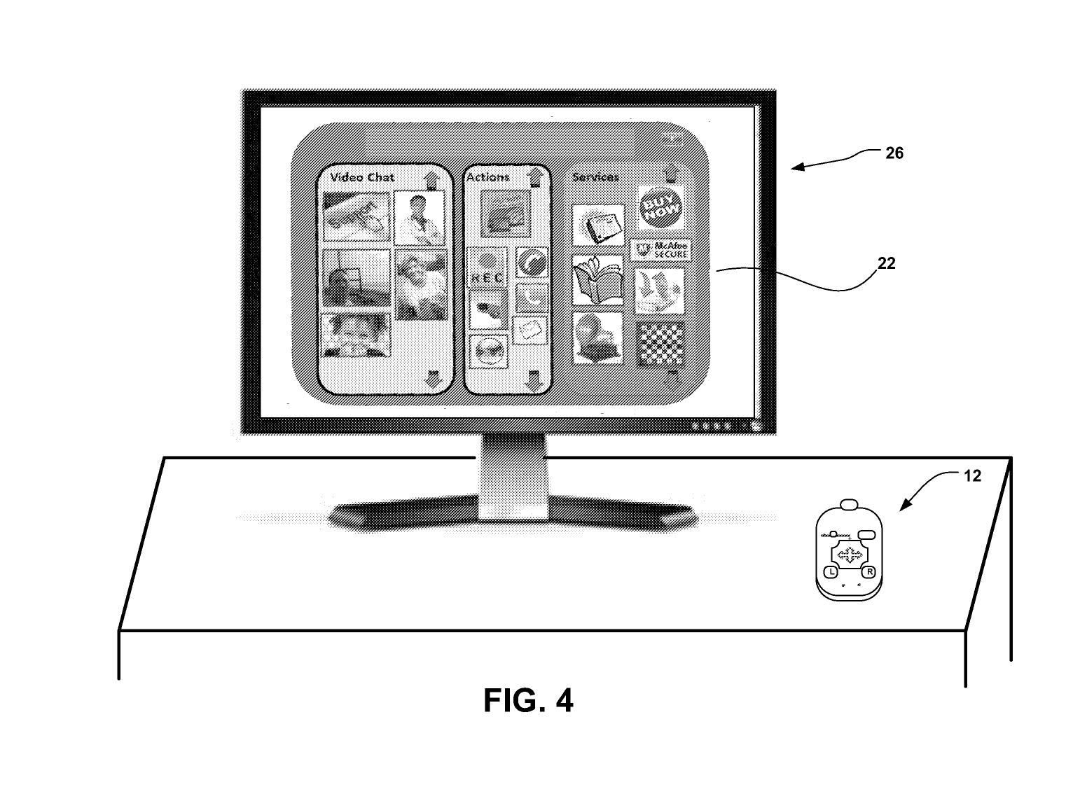

Turning to FIG. 4, an exemplary embodiment of a GUI 22 shown on the display 26 of the computing device 14 is illustrated. As shown, a system consistent with the present disclosure may include a GUI 22 that is simple in design and provides intuitive and user-friendly navigation and transitioning, such as, for example, PointerWare™ offered by PointerWare Innovations, Ltd. of San Francisco, Calif. In particular, the GUI 22 may be designed with a novice user in mind, wherein the GUI 22 may allow a user to navigate and access all aspects of a program by clicking through a series of buttons. As shown, all static preconfigured content may be presented in a single screen and content may be limited to only essential features in order to keep screen content minimized and readable. A user may navigate the GUI 22 via the user selectable function inputs 44 of the input device 12.

FIG. 5 illustrates another exemplary embodiment of a GUI 22 shown on the display of a computing device consistent with the present disclosure. As previously described, the input device 12 may include a camera 42 configured to capture images and/or video. The camera 42 may include any device (known or later discovered) for capturing digital images representative of an environment that includes, for example, printed information, and may have adequate resolution for text analysis of the printed information. The camera 42 may include a still camera (i.e., a camera configured to capture still photographs) or a video camera (i.e., a camera configured to capture a plurality of moving images in a plurality of frames).

As shown in FIG. 5, a user may utilize the input device 12 to process and/or magnify printed information for various purposes. For example, the camera 42 may be used to scan reading materials (e.g. newspaper 56, hard copy mail, etc.) or packaging from common household items (e.g. vision impaired persons may view food packages, medicine cautions, photographs, etc.). In the illustrated embodiment, the camera 42 may capture one or more images and/or video of a portion 58 of the newspaper 56, wherein the captured images and/or video may be transmitted to the computing device 14. In turn, the computing device 14 may transmit the images and/or video to the display 26, wherein the portion 58 of the newspaper 56 may be displayed. A user may control the size of the magnification of the portion 58 of the newspaper 56 with, for example, the magnifying input 50 of the input device 12. As generally understood by one skilled in the art, the computing device 14 may include software configured to stitch different images captured by the camera 42 into a single displayed image (i.e. smart manual scanning). Additionally, the computing device may further include other software applications configured to apply optical character recognition (OCR) and/or text to voice capabilities to the captured images and/or video of the printed text.

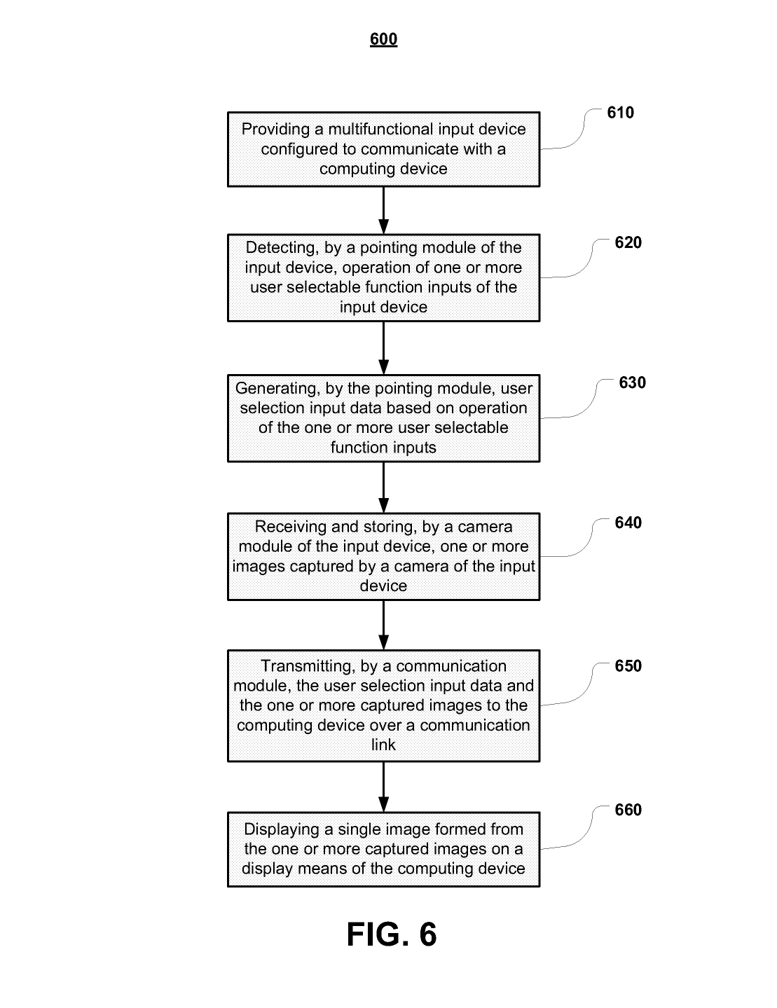

Turning now to FIG. 6, a flowchart of one embodiment of a method 600 for interacting with a graphical user interface (GUI) on a display means of a computing device is illustrated. The method 600 includes providing a multifunctional input device configured to communicate with a computing device (operation 610). The method 600 further includes detecting, by a pointing module of the input device, operation of one or more user selectable function inputs of the input device (operation 620). The method 600 further includes detecting, by a pointing module of the input device, operation of one or more user selectable function inputs of the input device generating, by the pointing module, user selection input data based on operation of the one or more user selectable function inputs (operation 630). The method 600 further includes receiving and storing, by a camera module of the input device, one or more images captured by a camera of the input device (operation 640). The method 600 further includes transmitting, by a communication module, the user selection input data and the one or more captured images to the computing device over a communication link (operation 650). The method 600 further includes displaying a single image formed from the one or more captured images on a display means of the computing device (operation 660).

While FIG. 6 illustrates method operations according various embodiments, it is to be understood that in any embodiment not all of these operations are necessary. Indeed, it is fully contemplated herein that in other embodiments of the present disclosure, the operations depicted in FIG. 6 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

Accordingly, a system consistent with the present disclosure may provide users with limited computer skills, knowledge, and/or abilities (e.g. novice users, elderly, etc.) a more accessible and user-friendly means of operating a computing device. In particular, a simplified GUI and input device consistent with the present disclosure may allow a user, who would otherwise be overwhelmed with current computing devices, to safely access the computing device, purchase services, make purchases over the internet, browse the internet, participate in social networking (e.g. video chat), and/or access email.

Consistent with one embodiment of the present disclosure, there is provided a multifunctional input device for a computing device. The multifunctional input device includes user selectable function inputs for allowing a user to interact with a graphical user interface (GUI) of the computing device on a display means. The multifunctional input device further includes a pointing module configured to detect operation of the one or more user selectable function inputs. The pointing module is further configured to generate user selection input data based on operation of the one or more user selectable function inputs. The multifunctional input device further includes a camera configured to capture one or more images and a camera module configured to receive and store the one or more images captured by the camera. The multifunctional input device further includes a communication module configured to transmit the user selection input data from the pointing module and the one or more captured images from the camera module to the computing device over a communication link. The multifunctional input device further includes a processor configured to control the communication module to communicate with the computing device.

Consistent with another embodiment of the present disclosure, there is provided a system for interacting with a graphical user interface (GUI) on a display means of a computing device. The system include a computing device and a multifunctional input device for allowing a user to interact with a graphical user interface (GUI) of the computing device on a display means. The multifunctional input device includes user selectable function inputs for allowing a user to interact with a graphical user interface (GUI) of the computing device on a display means. The multifunctional input device further includes a pointing module configured to detect operation of the one or more user selectable function inputs. The pointing module is further configured to generate user selection input data based on operation of the one or more user selectable function inputs. The multifunctional input device further includes a camera configured to capture one or more images and a camera module configured to receive and store the one or more images captured by the camera. The multifunctional input device further includes a communication module configured to transmit the user selection input data from the pointing module and the one or more captured images from the camera module to the computing device over a communication link. The multifunctional input device further includes a processor configured to control the communication module to communicate with the computing device.

Consistent with another embodiment of the present disclosure, there is provided a method for interacting with a graphical user interface (GUI) on a display means of a computing device. The method includes providing a multifunctional input device configured to communicate with a computing device. The method further includes detecting, by a pointing module of the input device, operation of one or more user selectable function inputs of the input device. The method further includes detecting, by a pointing module of the input device, operation of one or more user selectable function inputs of the input device generating, by the pointing module, user selection input data based on operation of the one or more user selectable function inputs. The method further includes receiving and storing, by a camera module of the input device, one or more images captured by a camera of the input device. The method further includes transmitting, by a communication module, the user selection input data and the one or more captured images to the computing device over a communication link. The method further includes displaying a single image formed from the one or more captured images on a display means of the computing device.

Consistent with yet another embodiment of the present disclosure, there is provided a computer accessible medium including instructions stored thereon. When executed by one or more processors, the instructions may cause a computer system to perform operations for interacting with a graphical user interface (GUI) on a display means of a computing device. The operations may include detecting, by a pointing module of a multifunctional input device, operation of one or more user selectable function inputs of the input device; detecting, by a pointing module of the input device, operation of one or more user selectable function inputs of the input device; generating, by the pointing module, user selection input data based on operation of the one or more user selectable function inputs; receiving and storing, by a camera module of the input device, one or more images captured by a camera of the input device; transmitting, by a communication module of the input device, the user selection input data and the one or more captured images to a computing device over a communication link; and displaying a single image formed from the one or more captured images on a display means of the computing device.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

As used in any embodiment herein, the term “module” refers to software, firmware and/or circuitry configured to perform the stated operations. The software may be embodied as a software package, code and/or instruction set or instructions, and “circuitry”, as used in any embodiment herein, may comprise, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), etc.

Certain embodiments described herein may be provided as a tangible machine-readable medium storing computer-executable instructions that, if executed by the computer, cause the computer to perform the methods and/or operations described herein. The tangible computer-readable medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The computer may include any suitable processing platform, device or system, computing platform, device or system and may be implemented using any suitable combination of hardware and/or software. The instructions may include any suitable type of code and may be implemented using any suitable programming language.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

What is claimed is:

1. A multifunctional input device for interacting with a graphical user interface (GUI) on a display of a computing device, said input device comprising:
user selectable function inputs to allow a user to interact with a graphical user interface (GUI) of said computing device on a display;
a pointing module configured to detect operation of said one or more user selectable function inputs and to generate user selection input data based on operation of said one or more user selectable function inputs;
a camera configured to capture one or more images;
a camera module configured to receive and store said one or more images captured by said camera;
a communication module configured to transmit said user selection input data from said pointing module and said one or more captured images from said camera module to said computing device over a communication link; and
a processor configured to control said communication module to communicate with said computing device.

2. The multifunctional input device of claim 1, wherein said camera module is configured to receive and store one or more images of printed information captured by said camera, and said communication module is configured to transmit said one or more images of printed information to said computing device to display on said display.

3. The multifunctional input device of claim 2, wherein one of said user selectable function inputs comprises a magnifying input configured to allow a user to vary the size of said one or more images of printed information captured by said camera on said display.

4. The multifunctional input device of claim 1, wherein one of said user selectable function inputs comprises a navigation input to allow a user to navigate said GUI.

5. The multifunctional input device of claim 1, wherein said processor is configured to control said communication module to transmit at least one of said user selection input data from said pointing module and said one or more captured images from said camera module to said computing device.

6. The multifunctional input device of claim 1, wherein said communication module comprises a wireless communication module to allow said input device to wirelessly communicate with said computing device via a wireless transmission protocol.

7. The multifunctional input device of claim 6, wherein said wireless transmission protocol is selected from the group consisting of Bluetooth, infrared, and IEEE 802.11 transmission protocol standards.

8. The multifunctional input device of claim 1, wherein said communication module comprises a wired connection module to allow said input device to communicate with said computing device via a transmission cable and a wired transmission protocol.

9. The multifunctional input device of claim 8, wherein said wired transmission protocol is a universal serial bus (USB) transmission protocol.

10. The multifunctional input device of claim 1 comprising:
a microphone configured to capture audio data; and
a microphone module configured to receive and store audio data captured by said microphone,
wherein said communication module is configured to transmit said captured audio data from said microphone module to said computing device.

11. The multifunctional input device of claim 10, wherein said processor is configured to control said communication module to transmit audio data from said microphone module to said computing device.

12. The multifunctional input device of claim 1 comprising:
an audio module configured to receive audio data from said computing device; and
an audio output configured to aurally reproduce audio data from said audio module,
wherein said communication module is configured to transmit said audio data from said computing device to said audio module.

13. The multifunctional input device of claim 12, wherein said processor is configured to control said communication module to receive audio data from said computing device.

14. The multifunctional input device of claim 1, wherein said computing device is selected from a group consisting of a personal computer (PC), a netbook, a tablet, and a Smartphone.

15. A system for interacting with a graphical user interface (GUI) on a display of a computing device, said system comprising:
a computing device; and
a multifunctional input device to allow a user to interact with a graphical user interface (GUI) of said computing device on a display, said multifunctional input device comprising:
user selectable function inputs to allow a user to interact with said GUI;
a pointing module configured to detect operation of said one or more user selectable function inputs and to generate user selection input data based on operation of said one or more user selectable function inputs;
a camera configured to capture one or more images;
a camera module configured to receive and store said one or more images captured by said camera;
a communication module configured to transmit said user selection input data from said pointing module and said one or more captured images from said camera module to said computing device over a communication link; and
a processor configured to control said communication module to communicate with said computing device.

16. The system of claim 15, wherein said camera module is configured to receive and store one or more images of printed information captured by said camera, and said communication module is configured to transmit said one or more images of printed information to said computing device to exhibit on said display.

17. The system of claim 16, wherein one of said user selectable function inputs comprises a magnifying input configured to allow a user to vary the size of said one or more images of printed information captured by said camera on said display.

18. The system of claim 15, wherein one of said user selectable function inputs comprises a navigation input to allow a user to navigate said GUI.

19-23. (canceled)

24. The system of claim 15, wherein said multifunctional input device comprises:
a microphone configured to capture audio data; and
a microphone module configured to receive and store audio data captured by said microphone;
wherein said communication module is configured to transmit said captured audio data from said microphone module to said computing device.

25-28. (canceled)

29. A method for interacting with a graphical user interface (GUI) on a display of a computing device, said method comprising:
providing a multifunctional input device configured to communicate with said computing device;
detecting, by a pointing module of said input device, operation of one or more user selectable function inputs of said input device;
generating, by said pointing module, user selection input data based on operation of said one or more user selectable function inputs;
receiving and storing, by a camera module of said input device, one or more images captured by a camera of said input device;
transmitting, by a communication module of said input device, said user selection input data and said one or more captured images to said computing device over a communication link; and
displaying a single image formed from said one or more captured images on said display.

30. The method of claim 29, wherein said one or more images contain printed information containing at least some text.

31. (canceled)

32. The method of claim 29, wherein one of said user selectable function inputs comprises a magnifying input configured to allow a user to vary the size of said image displayed on said display.

33-38. (canceled)

39. At least one non-transitory computer accessible medium including instructions stored thereon which, when executed by one or more processors, result in:
detecting, by a pointing module of a multifunctional input device, operation of one or more user selectable function inputs of said input device, said multifunctional input device configured to communicate with a computing device;
generating, by said pointing module, user selection input data based on operation of said one or more user selectable function inputs;
receiving and storing, by a camera module of said input device, one or more images captured by a camera of said input device;
transmitting, by a communication module of said input device, said user selection input data and said one or more captured images to said computing device over a communication link; and
displaying a single image formed from said one or more captured images on a display.

40. The computer accessible medium of claim 39, wherein said one or more images contain printed information containing at least some text.

41. The computer accessible medium of claim 39, wherein one of said user selectable function inputs comprises a magnifying input configured to allow a user to vary the size of said image displayed on said display.
